(19) United States
(12) Patent Application Publication
(10) Pub. No.: US 2019/0303933 A1
(43) Pub. Date: Oct. 3, 2019

(54) NOVEL APPLICATION OF BLOCKCHAIN DATA STRUCTURE FOR INSURANCE CERTIFICATE MANAGEMENT

(71) Applicants: JOHN PAUL LINDSAY, (US); ROY MALIK LINDSAY, (US); JOSE PAOLO RECIO HUELGAS, (US)

(72) Inventors: JOHN PAUL LINDSAY, MINNEAPOLIS, MN (US); ROY MALIK LINDSAY, MINNEAPOLIS, MN (US); JOSE PAOLO RECIO HUELGAS, MANALAPAN, NJ (US)

(73) Assignee: BITWAGE, INC., SAN FRANCISCO, CA (US)

(21) Appl. No.: 16/432,870

(22) Filed: Jun. 5, 2019

(51) Int. Cl. G06Q 20/40; H04L 9/32; G06Q 40/08

(52) U.S. Cl. CPC G06Q 20/401; H04L 9/3247; H04L 2209/56; G06Q 2220/00; G06Q 40/08

(57) ABSTRACT

The present invention comprises a novel application of blockchain data structure for insurance certificate management generally consisting of an application server with logic for receiving and depositing insurance certificates, a private datastore for privately storing information, a translation element for translating information into the language of the blockchain data structure, and a blockchain structure. The blockchain structure is generally composed of cryptographically linked blocks, a tree that bundles transactions, and transactions as the base element with input and output components and a sending function with a cryptographic signature. The present invention therefore allows for four actions: putting to a private datastore, putting to a private datastore with a cryptographic hash to public blockchain data structure, fetching from a private datastore, and fetching directly from a public blockchain data structure.

### FIELD OF THE INVENTION

The present invention relates to novel application of blockchain data structure for insurance certificate management. More particularly, the invention relates to a platform for the managing of insurance certificate data via a blockchain protocol.

### BACKGROUND

The blockchain data structure has been a fast growing area of interest for many cryptography professionals. The primary interest is from the long term data security offered by the technology.

Insurance certificates must be stored to be able to be referenced in the event of a claim following the signing of an insurance contract. Software and platforms for following and enforcing these contracts have incorporated different database and payment technologies.

There have been challenges with respect to matching the correct database and payment technologies to the types of digital contracts being created and sold.

### BRIEF SUMMARY OF THE INVENTION

The present invention comprises a novel application of the blockchain data structure consisting of a device capable of receiving a signed insurance contract, inserting the contract on a blockchain, and later retrieving the contract from the blockchain.

The invention includes a data store to store the insurance contract file before interacting with the blockchain and the associated information and logic to display and issue the contract to the insurance contract provider and post and retrieve from the blockchain. Other components include the ability to track past issuances to insurance contract providers, past interactions with the blockchain, as well as monitor for false interaction attempts.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 depicts the basic view of one example of a blockchain data structure which is a component of various embodiments of the present invention.

FIG. 2—FIG. 2 depicts the basic view of one example of a blockchain transaction which is a component of various embodiments of the present invention.

FIG. 3—FIG. 3 depicts the basic view of one example of a design for applying blockchain data structure for insurance certificate management which is an embodiment of the present invention.

### DETAILED DESCRIPTION OF THE INVENTION

The terminology used herein is for the purpose of describing particular embodiments only and is not intended to be limiting of the invention. As used herein, the term “and/or” includes and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure will not be interpreted as an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nethertheless, the specification and claims should be read with the understanding that such combinations are entirely within the scope of the invention and the claims.

Novel applications of blockchain data structures for insurance certificate management are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

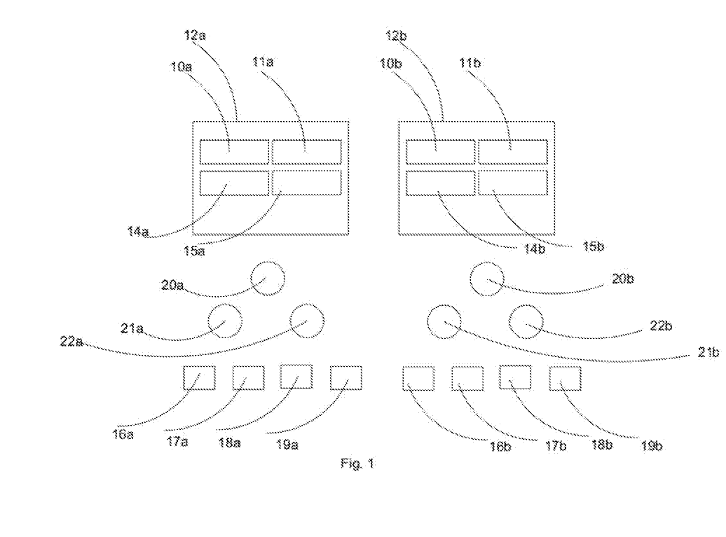

The present invention will now be described by referencing the appended figures representing preferred embodiments. FIG. 1 depicts the basic view of the elements that may comprise a blockchain data structure which is a component of various embodiments of the present invention. In preferred embodiments of the present invention, the configuration is a series of blocks, the first block labeled 12a, and the second block labeled 12b. Within each block there are four components: the hash labeled 10a, the timestamp labeled 11a, the transactions labeled 14a, and the nonce labeled 15a.

The relation between blocks is such that the cryptographic hash of block labeled 12a is the hash labeled 10b of the next block labeled 12b. The transaction components 14a and 14b are themselves derived from cryptographic merkle trees which are composed, respectively, of hashes 20a and 20b, which are themselves composed, respectively, of hashes 21a and 22a, and 21b and 22b, which are themselves composed of transactions, for example, 21a is composed of 16a and 17a, and 22a is composed of 18a and 19a, although there is not necessarily a limit of two transactions at the base of a merkle tree.

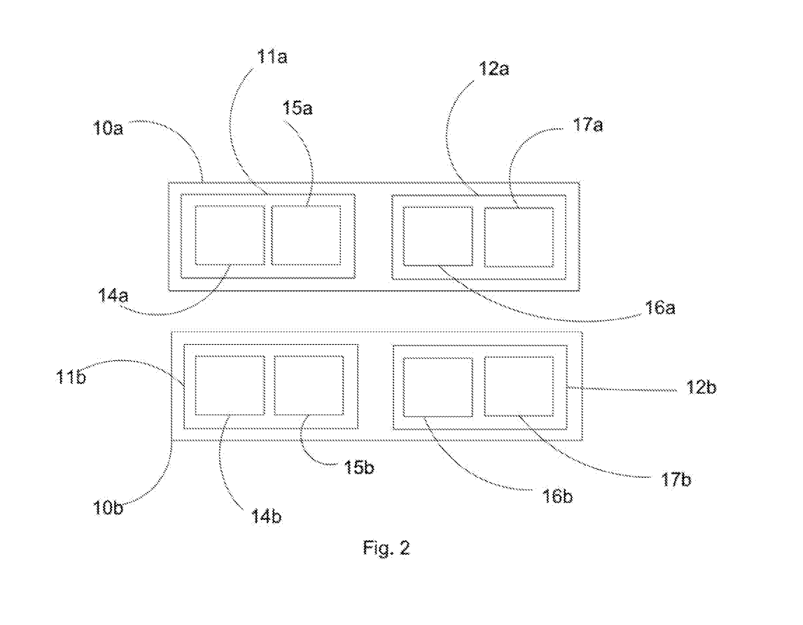

FIG. 2 depicts the basic view of the elements that may comprise a transaction as labeled 16a, 17a, 18a, 19a, 16b, 17b, 18b, and 19b in FIG. 1. In particular the element labeled 10a in FIG. 1 may, for the purpose of this explanation, correspond to element 16a in FIG. 1, and the element labeled 10b in FIG. 1 may, for the purpose of this explanation, correspond to element 16b in FIG. 1.

FIG. 2 shows two transaction elements labeled 10a and 10b. Each transaction element has a transaction input object, labeled 11a and 11b, and a transaction output object, labeled 12a and 12b. Each transaction input object (11a and 11b) and transaction output object (12a and 12b) has a series i.e. list of pairs of value and address objects. In this example the value objects are 14a, 16a, 14b, and 16b, and the address objects are 15a, 17a, 15b, and 17b. So the value address pairs are 14a and 15a, 16a and 17a, 14b and 15b, and 16b and 17b. There is not necessarily a limit of one value address pair in the list of pairs of value and address objects in the transaction input (11a and 11b) and output (12a and 12b) objects.

In the described embodiment of the present invention, information is stored in the value fields 14a, 16a, 14b, and 16b through a number, and location of the information is stored in the address fields 15a, 17a, 15b, and 17b through a public key derived from asymmetric cryptography, also known as public key cryptography. The corresponding private key is stored privately.

The transaction element labeled 10a in FIG. 2, corresponding to transaction element 16a in FIG. 1, can be used to denote the sending of information denoted by value field 14a stored in location denoted by address field 15a into information denoted by value field 16a stored in location denoted by address field 17a.

The sending operation requires a cryptographic signature which ensures only the entity with the corresponding private key, stored privately, of address field 15a, is able to control the value in value field 14a. The sending operation then bundles the transaction element labeled 10a in FIG. 2 i.e. 16a in FIG. 1 into the cryptographic merkle tree as described above and thereafter into the transaction element 14a of block element 12a in FIG. 1. The previous block (not shown here) is cryptographically hashed into element 10a, as described in section [00016] when describing the relation between blocks. Together with elements 11a and 15a, the block 12a is then publicly and physically broadcasted to be stored publicly and physically by the various participants listening and ready to receive blocks.

The relation between transaction elements is such that the value and address object pairs labeled 16a and 17a within the transaction output object labeled 12a of transaction element labeled 10a become the value and address object pairs labeled, for the sake of example, as 14b and 15b within the transaction input object labeled 11b of transaction element labeled 10b. In the embodiment shown here of the present invention, where the transaction element labeled 10a in FIG. 2 corresponds to transaction element 16a in FIG. 1 and the transaction element labeled 10b in FIG. 2 corresponds to transaction element 16b in FIG. 1, if the value and address object pairs 16a and 17a become the value and address object pairs 14b and 15b, this act of becoming happens after the transaction element object 10b of FIG. 2 (16b of FIG. 1) is signed as described in section [00021].

Because of the computation power required to generate a signature as described in section [00021] due to cryptographic principles, and because each block is related to one another as described in section [00016], as more blocks are generated and received by the participants there is a persistence property of blockchain data structures where once written the information cannot be removed assuming limited adversarial computation power.

The application this invention is using the above described blockchain data structure for is insurance certificate management. Here, the value field is the information contained in the insurance certificate, and the location information field is who is being issued the insurance certificate.

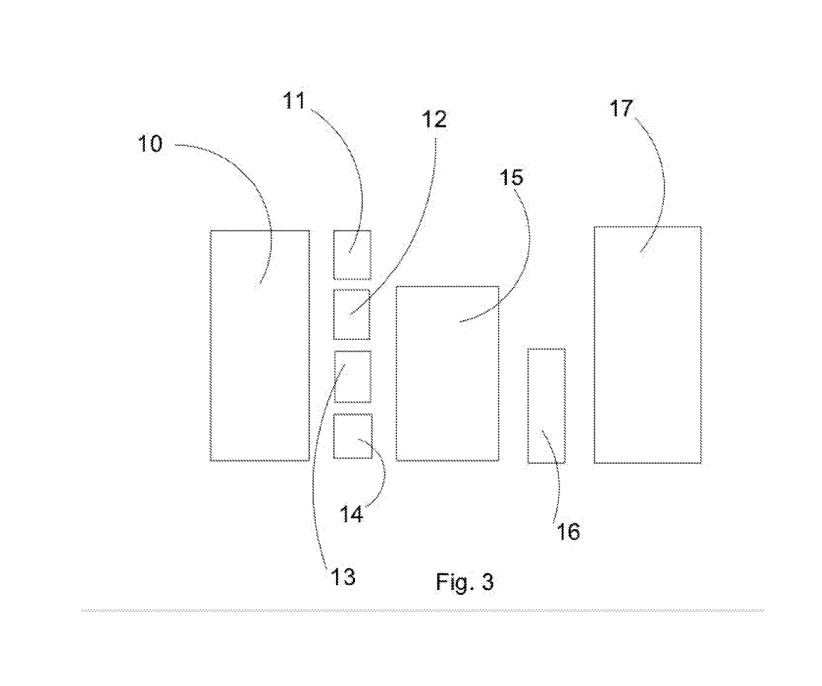

FIG. 3 depicts the elements of one example of a design for applying blockchain data structure for insurance certificate management which is an embodiment of the present invention. The application server element, labeled 10, has logic and temporary memory and other standard parts of an application server. The private datastore, labeled 15, stores data in a physical private location. The blockchain data structure, labeled 17, stores data in a public decentralized manner as described above and shown in FIG. 1 and FIG. 2.

The hashing element, labeled 16, translates data from its native form into the language of the blockchain. For example in the blockchain described in FIG. 1 and FIG. 2, the blockchain uses a list of pairs of value and address objects, and so this hashing element, labeled 16, translates insurance certificate information, roughly speaking, into lists of pairs of value and address objects.

The current example of the present invention requires actions 11, 12, 13, and 14 to be taken by the application server, labeled 10, to interact with elements 15, 16, and 17. Actions 12 and 14 are putting actions i.e. putting information. Actions 11 and 13 are fetching actions i.e. taking information.

Action 12 is a private put and so it puts information only to the private datastore, labeled 15. Action 14 is a public put and so it puts information to the public blockchain data structure, labeled 17. The public put operations happens by first putting information into the private datastore, labeled 15, and then putting information from there to the hashing element, labeled 16, and from there to the public blockchain data structure, labeled 17.

Action 13 is a private fetch and so it fetches information only from the private datastore, labeled 15. This information can include both information only privately put (action 12) or also information publicly put (action 14). Action 11 is a public fetch and so it fetches information directly from the public blockchain data structure, labeled 17.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A blockchain data structure for storing insurance certificate information the data structure comprising:
a. Blocks cryptographically hashed from the previous
b. The transaction hash component being cryptographically derived from a merkle tree of transactions
c. The transactions having an input and output and a sending function with a cryptographic signature

2. An insurance certificate information flow design that takes information from an application server and uses a private datastore and a translation element to enable four actions namely:
a. Putting action to private datastore
b. Putting action to private datastore with hash to public blockchain data structure
c. Fetching action from private datastore
d. Fetching action direct from public blockchain data structure
